(19) United States
(12) Patent Application Publication
(10) Pub. No.: US 2005/0206610 A1
(43) Pub. Date: Sep. 22, 2005

(54) Computer-"reflected" (avatar) mirror

(76) Inventor: Gary Gerard Cordelli, Indialantic, FL (US)

Correspondence Address: Gary G. Cordelli, 404 Rio Villa Boulevard, Indialantic, FL, 32903, US

(21) Appl. No.: 09/962,548

(22) Filed: Sep. 21, 2001

Related U.S. Application Data
(60) Provisional application No. 60/236,183, filed on Sep. 29, 2000.

(51) Int. Cl. G09G 5/00

(52) U.S. Cl. 345/156

(57) ABSTRACT

The mirror of the present invention provides a new device and method for generating a “reflection” of an object that may be processed before display. The invention comprises an image-capture system, an image-processor and a flat-panel display. By this combination, the invention is capable of acquiring the image of a subject in front of the display by passive means not requiring transmitters or reflectors on the subject (such means including optical, ultra-sonic, and electromagnetic sensors), processing the image in programmable ways to create an altered image of the subject and displaying the new image, which appears to mimic the movement and orientation of the original subject.

Claims priority benefit of U.S. Provisional Application 60/236,183 filed on Sep. 29, 2000 Claims priority benefit of U.S. Non-Provisional Application 09/962,548 filed on Aug. 21, 2001

### REFERENCES

U.S. PATENT DOCUMENTS
U.S. Pat. No. 5,987,456 filed on Nov. 16, 1999 by, Ravela, et al. . . 707/5
U.S. Pat. No. 5,987,154 filed on Nov. 16, 1999 by Gibbon, et al. . . . 382/115
U.S. Pat. No. 5,982,929 filed on Nov. 9, 1999 by Ilan, et al. . . 382/200
U.S. Pat. No. 5,982,390 filed on Nov. 9, 1999 by Stoneking, et al. . . 345/474
U.S. Pat. No. 5,983,120 filed on Nov. 9, 1999 by Groner, et al. . . 600/310
U.S. Pat. No. 5,978,696 filed on Nov. 2, 1999 by VomLehn, et al. . . 600/411
U.S. Pat. No. 5,977,968 filed on Nov. 2, 1999 by Le Blanc . . . 345/339
U.S. Pat. No. 5,969,772 filed on Oct. 19, 1999 by Saeki . . . 348/699
U.S. Pat. No. 5,963,891 filed on Oct. 5, 1999 by Walker, et al. . . 702/150
U.S. Pat. No. 5,960,111 filed on Sep. 28, 1999 by Chen, et al. . . 382/173
U.S. Pat. No. 5,943,435 filed on Aug. 24, 1999 by Gaborski . . . 382/132
U.S. Pat. No. 5,930,379 filed on Jul. 27, 1999 by Rehg, et al. . . 382/107
U.S. Pat. No. 5,929,940 filed on Jul. 27, 1999 by Jeannin . . . 348/699
U.S. Pat. No. 5,915,044 filed on Jun. 22, 1999 by Gardos, et al . . . 382/236
U.S. Pat. No. 5,909,218 filed on Jun. 1, 1999 by Naka, et al . . . 345/419
U.S. Pat. No. 5,880,731 filed on Mar. 9, 1999 by Liles, et al . . . 345/349
U.S. Pat. No. 5,831,620 filed on Nov. 3, 1998 by Kichury, Jr. . . 345/419
U.S. Pat. No. 5,684,943 filed on Nov. 4, 1997 by Abraham, et al. . . 395/173
U.S. Pat. No. 4,701,752 filed on Oct. 20, 1987 by Wang . . . 340/723

### BACKGROUND OF THE INVENTION

The present invention relates to the field of computer image processing. In particular, this invention relates to a system for the generation of 2D/3D “reflections” of a subject. More specifically, the invention directs itself to a system that allows an electronic mirror-like device to display an altered version of the subject or an “avatar” of the original subject; that is, an alternate persona that can mimic the movement and orientation of the subject.

Mankind has used reflective surfaces to view their appearance perhaps since the first human looked down into a puddle of water. It is possible that even in the Stone Age humans learned that a polished stone surface could be made to reflect their image. It is certain that by the Bronze Age polished metal surfaces were used by humans as mirrors.

Purely optical mirrors have existed for many centuries. These devices have been constructed of various materials, each sharing the attribute of high optical reflectivity. When a subject is positioned before the reflective surface of such mirrors, an image of the subject is produced. This image may be altered from the actual appearance by imperfections in the mirror surface or by inherent attributes of the mirror material. In such cases, this alteration is generally considered to be an unwanted by-product of the mirror's construction.

In modern times, amusement park “fun houses” used optical mirrors with intentional planar imperfections. Each mirror was designed with imperfections that induced specific distortions in the subject reflection. In this way, the subject could be made to look fatter, shorter, thinner, taller or “wavy”, among other effects. The reflected image, however, was still essentially recognizable as that of the subject.

With the advent of electronic computers, the field of image processing was born. Image processing computers could create realistic images from data. At first, the data input was simply constructed from equations for simple shapes. Later, multi-axis positional sensors allowed users to define data sets representing real-world objects. Advances in optical sensor technologies later allowed for data to be input directly from visual images of real-world objects. In each case, the focus has been on the faithful representation of the object being displayed.

With time, however, sophisticated image-processing systems have allowed movie producers to create on-screen characters that do not exist in the reality. In such cases, a human subject might be used as a model for the screen character. A wire-frame or “skeletal” image could be derived from this subject's captured image, and a new surface representing the outside “skin” (e.g., costume) of the screen character could be “painted” on this frame. Creating these imaginative characters is accomplished by time-consuming off-line processing before the images are transferred to film for display.

Recent advances in video game technology have created some rudimentary “immersive” games, which seek to place an unaltered image of the game player into the game context. These games use PC video cameras to capture the user's live image and insert it into the computer-generated graphic game world. The capability to synchronize a video signal with a computer display (“genlock”) has existed for many years, but the new technology provides the additional capability for the computer to recognize which areas of the combined image are from the video input and which are from the computer output. Inevitably, limited recognition of some basic movements such as hand and body movements (e.g., “jump”) will eventually be used to control the game.

What is envisioned in the current invention is a image-processing system that combines the real-time reflective capability of the traditional mirror with the display of imaginative characters in such a way as to mimic the movements and orientation of the original subject. All of this should be accomplished without the requirement of tracking targets affixed to a subject. The input data describing the position and orientation of the various body segments of the subject should be derived entirely from non-contact sensing means not requiring alterations or additions made to the subject body. These means include optical, ultra-sonic and/or electromagnetic sensing devices. Ancillary information regarding the presence of a subject or subjects and their relative positions with respect to the invention may be gathered using similar sensors and/or a pressure-sensitive surface below the subjects.

Several patents have been granted in the area of image segmentation, especially in the area of foreground/background segmentation (the separation of moving foreground objects from a moving or stationary background), for example, in [Chen]. Most of these patents, however, have been directed toward methods of reducing the bit-rate (bandwidth) required to transmit motion video information between two computers, especially over the internet, for example, in [Chen], [Saeki], [Jeannin], [Gardos] and [Naka]. The current invention has no remote image-data transmission requirements and may perform segmentation in several ways without reliance on the methods described in these earlier patents. As to background discrimination, the mirror of the present invention is only interested in recognition of the subject(s) near its display surface. The current invention can therefore distinguish “foreground” from “background” by methods not drawing on these earlier patents, as put forth in the preferred embodiment description of this application.

Various methods of recognizing specific objects in images have also received patents. The methods have covered tasks as diverse as recognizing, for example, alphanumeric characters to accept handwritten input (as in [Ilan]); internal organs/bones to classify radiographic images (as in [Gabroski]) or to guide surgical procedures (as in [VomLehn]). Some are directed toward the recognition of specific parts of the human form, such as [Gibbon], which seeks to force a video camera to center a human head within its view frame. Others, such as [Ravela] and [Rehg], are directed towards detecting a multitude of human body forms in still images or body movements in video sequences. In each case, the methods are directed toward controlling some external device with respect to the moving form or by use of specific “gestures”, or for non-real-time content-based video indexing, retrieval and editing. None, however, are directed toward or appropriate to the real-time capturing of the entire human form for graphic manipulation and reproduction.

On the output side, “avatars” have been the subject of several patents in the area of controlling the appearance, movement and/or viewpoint of such graphic objects. [Le Blanc], for example, describes a method for selecting a facial expression for a facial avatar to communicate the user's attitude. [Liles] takes this a step further with a method for selecting one of several pre-defined avatar poses to produce a gesture conveying an emotion, action or personality trait, such as during a “chat” session with other users (also represented by similar avatars). However, these methods only allow the selection of one of a predefined set of facial or full-body graphic icons using manual input denoting the intended expression or attitude, and are unrelated to the task of recognizing a human form and generating an avatar in real-time to mimic that form.

The encoding of data representing moving human forms has been the subject of several patents as well. [Walker] is but one example of an apparatus for tracking body movements through the use of multiple sensors attached to a subject's body or to clothes worn by the subject to measure joint articulation and/or rotation. This system is directed toward controlling the movement and viewpoint of an avatar of the user in a virtual world. The methods encompassed by the patents similar to [Walker] all require subject-mounted “targets” (i.e., sensors or active signal sources). Some of these methods use optical reflectors or active IR LEDs placed at various points on the surface of the subject. Laser projectors and cameras or IR detectors can then be used to track the position of these devices in order to capture a “skeletal” or “wire-frame” image of the subject. Other methods use a magnetic field generator to sense the position of multiple magnetic coils worn by the user as they move through the field. This latter method allows the tracking of all targets even when visually obscured by some part of the subject body. Since each of these methods require the subject to wear a special “exo-skeleton” of targets, none are appropriate for the task of recognizing movement in arbitrary human forms positioned in front of the current invention.

[Abraham] takes the opposite approach to [Walker] and others, using head-mounted virtual reality display “glasses” to place the user into a computer-generated continuous cylindrical virtual world. This invention uses sensors on the “glasses” to control the user's perspective from inside this world without requiring the display of the user's image within that context (i.e., the user is located at the viewpoint). Since [Abraham] seeks to mimic a surrounding environment rather than the subject, the methods described therein are also not appropriate to the task of the current invention.

[Stoneking] addresses an obscure problem that will eventually come to concern owners of copyrighted animated characters licensed for use in video games, etc. In this patent, the inventor describes a method of incorporating within a given character object a “personality object” that can prevent unauthorized manipulations of the character or to enforce constraints on the character's actions to avoid damage to the public image or commercial prospects of the character's owner. Since the current invention envisions avatars configured specially for use in the device that embodies the invention, constraints on avatars will be defined within the software in the device rather than within the data object that defines the avatar. For example, it is likely that the “mirror” device of the current invention would be programmed not to mimic obscene gestures made by the subject without respect to the specific avatar object itself.

Mirrors and computers graphics have been linked in several patents, but all of these directed toward the proper display of reflective surfaces within a computer-generated scene. These patents, such as [Kichury] and [Wang], describe methods of determining the field-of-view relative to such a reflective surface within the image with respect to the original viewpoint of the user (viewing the surface). Thus, a mirror or semi-transparent glass surface depicted in a graphic scene can be made to accurately reflect the appropriate other objects within the same scene from the correct perspective. These patents are all related to determining the appropriate portion of a graphic scene to display within the perimeter of the reflective surface relative to the complex geometry of the scene, as represented by image data points. Displaying a “reflection” of a scene found external to the computer is not covered in any of these prior inventions.

### BRIEF SUMMARY OF THE INVENTION

The computer-“reflected” mirror of the present invention comprises both an apparatus and a method of displaying 2D and 3D images of characters that mimic the movements and orientation of the actual subjects positioned in front of the invention.

First, the present invention uses a flat-panel display to render the 2D and/or 3D images of the “avatar” characters.

Second, the present invention uses optical (visible and/or infrared), ultra-sonic and/or electromagnetic sensors to determine the presence and position of a subject in front of the flat-panel display surface.

Third, one or more simple detection mechanisms may be employed to create a “mask” to separate the background from the subject(s) within the “active” foreground area of the invention. This mechanism provides the means for ignoring any objects at a greater than programmable distance as part of the “background”. To discourage physical contact with the display surface, it may also ignore objects at less than some minimum distance. This mechanism may employ a simple ultra-sonic ranging sensor array mounted within the display unit. Ultra-sonic or optical (visible and/or infrared) “image” capture sensors placed orthogonal to the display surface in a field within a fixed range of said surface may also be used to detect the body or bodies of interest. A pressure-sensitive surface may also be placed in front of the display surface and below the subjects to detect the presence and position of the subjects, the dimensions and position with respect to the display of said surface defining the active foreground area of the invention. IR sensors in the display frame may also be used to detect subject bodies against the cooler background. An optional fixed background panel may be placed parallel to and at a distance from the display surface to provide a known background image. This panel may use a color and/or pattern to aid in the discrimination of subjects between the sensors and the panel. It would in any case provide automatic “masking” of objects more distant from the display surface than the panel. In all cases, the actual background video may be reproduced faithfully or optionally may be replaced by a programmed background.

Forth, the present invention uses an image-processor to segment the input sensor data to detect the various major body parts of a subject and determine the position and orientation of these segments. Segmentation allows the invention to interpret the video input as a collection of objects (i.e., body parts) rather than a matrix of dissociated pixels. This process is aided by pre-programmed models describing expected subject body parts, such as the human head, arms, legs, torso, hands, etc.

Finally, the present invention combines this body segment position and orientation data with stored image data of various “avatar” characters to generate the real-time “reflection” using the “avatar” image so that it mimics the actual subject position and orientation.

### BRIEF DESCRIPTION OF THE SEVERAL VIEWS OF THE DRAWINGS

FIG. 1 is a schematic view showing the basic subsystems comprising the present invention;

FIG. 2 is a schematic view showing the physical configuration of the present invention in one expected embodiment thereof, and showing the relationship between the subject positioned before the present invention and the image produced.

FIG. 3 is an illustration of the invention suitable for a Front Page View.

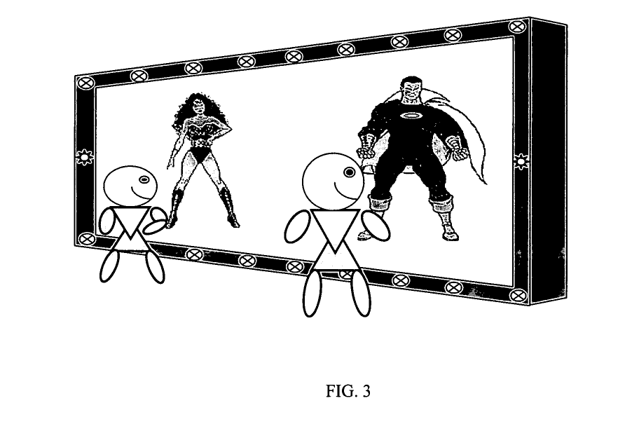

### DETAILED DESCRIPTION OF THE INVENTION

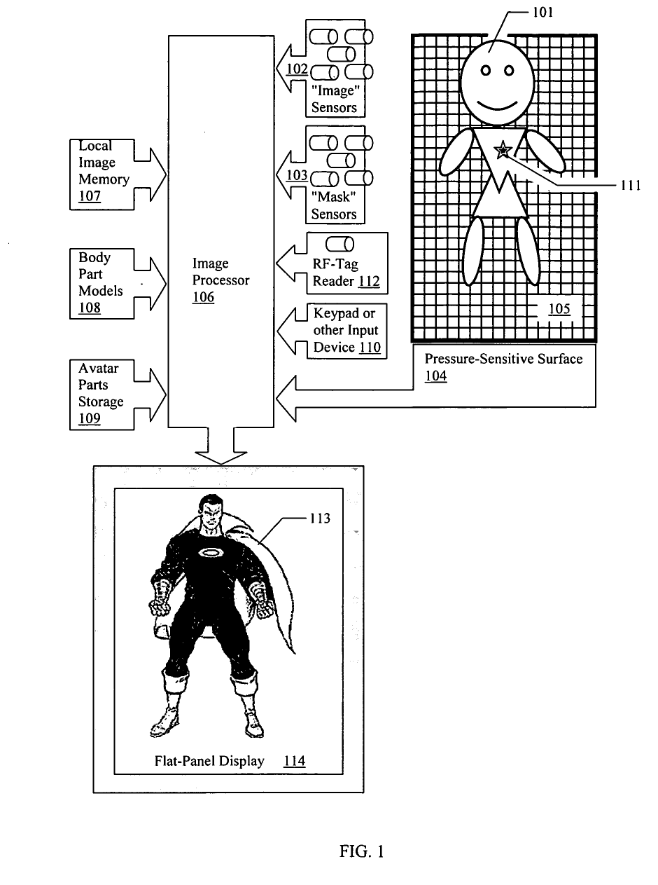

Referring first to FIG. 1, a subject (101) is positioned before the “image” sensors (102) and optional “mask” sensors (103) and on top of the optional pressure-sensitive pad (104). The latter set of sensors may be used to form an input “mask” with which to qualify the “image” data acquired by the subject sensors. This “mask” would represent all objects within the desired “foreground” range of the system. This qualification would allow the “image” data to discard any objects beyond this range as part of the “background”. An optional panel (105) with a color scheme and/or pattern chosen to aid in the discrimination of the edges of subject body parts may be positioned parallel to, and at a distance from, the display surface so that the subjects are between that surface and the display panel.

The data are applied to the image processor (106) where the raw “image” data is qualified by the “mask” as appropriate, in order to eliminate the “background” from the complete image. If the optional panel is used, the prescribed panel background color/pattern information forms its own “mask” and can be discarded from the total captured “image” data set. The resultant input “image” is stored in local memory (107). The image processor also derives position and orientation information for the subject's various limbs and major body segments from the input “image”.

In may be desirable for this process to be able to differentiate between multiple simultaneous subjects if used in a context where multiple subjects are present. Pre-programmed models of the basic “parts” that comprise a human form (108) may be used to collate and segregate individual parts into separate subjects.

The image processor retrieves image data for a selected “avatar” from persistent storage (109), wherein body-part image data for a set of multiple pre-programmed avatars is stored. An “avatar” selection is made in one of several ways. One selection method is through manual operator selection, such as through a keypad, mouse, touch-sensitive panel or other means (110). The selection could also be made automatically by the image processor either by random choice or by matching characteristics of the input “image” with characteristics of the stored avatars (such as relative height). Finally, a semi-automatic method might use an optional IR or RF “tag” (111) that is readable by an IR/RF reader (112) connected to the image processor and which the subject may select before entering the input area of the invention. The image processor assembles the avatar body-part data in such a way as to mimic the position and orientation of the body segments in the input “image”. The resultant “avatar” image (113) is then output to the flat-panel display (114) for viewing.

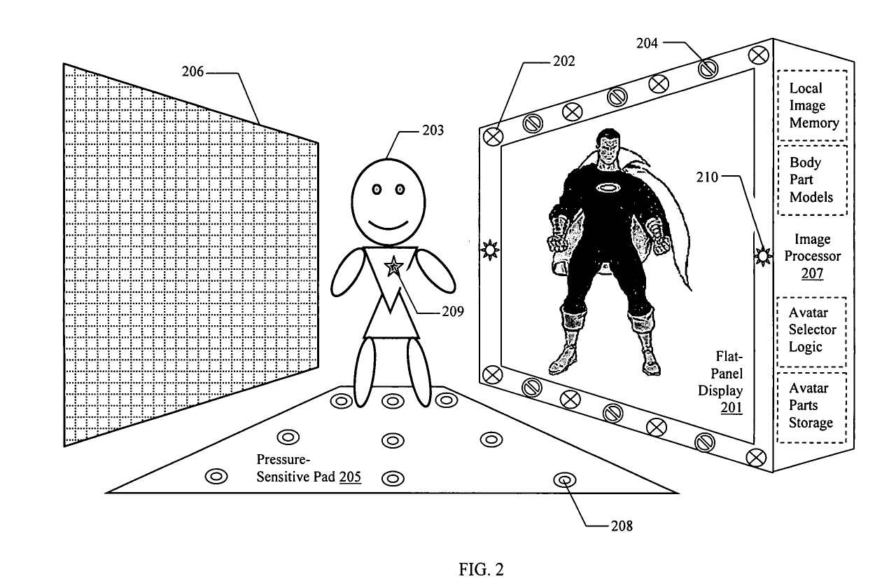

In FIG. 2, the physical arrangement and configuration of the invention is shown in on expected embodiment. In this configuration, the flat-panel display (201) is positioned vertically at ground level. The input “image” sensors (202) are installed around the perimeter of the display face, directed toward the viewers of the display. These sensors provide feedback as to the presence of a subject (203) before the “mirror”, and provide enough data to capture an “image” describing the position and orientation of the subject's various limbs and body segments.

In this configuration, ultrasonic sensors (204) capture distance information to objects in front of the “mirror”. These sensors may be mounted within the display frame or orthogonal to the display surface (i.e., above, below or beside the display). These sensors are used to determine when a subject comes within the “active range” in front of the display face. In addition, they may be used to form the input “mask”. An optional pressure-sensitive pad (205) may be used alternatively to determine the presence and position of a subject within the “active range” of the invention. An optional panel (206) with a color scheme and/or pattern chosen to aid in the discrimination of the edges of subject body parts may be positioned parallel to, and at a distance from, the display surface so that the subjects are between that surface and the display panel.

When a subject is detected within the “active range”, the image processor and storage subsystem (207) accepts and stores the total captured “image” data set from the input sensors. It applies the “mask” using the distance or color/pattern information in order to eliminate the “background” from the complete input “image”. The image processor retrieves data representing the selected “avatar” character from its persistent storage and combines this information with the masked input “image” data from the sensors to produce the current image data. The current image data is then fed in real-time to the flat-panel display to produce the final image output.

To handle multiple simultaneous subjects, the display-mounted optic or ultrasonic sensors (202, 204) may be used to provide “3D” information, or a simple array of sensors (208) may be arranged beneath the subjects so as to detect the mass of subject bodies to help group parts with each subject body.

An optional avatar selector tag (209) may be carried or worn by the subject to force the selection of a specific avatar from one of a number of stored avatars. This tag may be “read” using an IR or RF sensor system installed within the display frame (210).

Although the invention has been described with reference to the particular figures herein, many alterations and changes to the invention may become apparent to those skilled in the art without departing from the spirit and scope of the present invention. Therefore, included within the patent are all such modifications as may reasonably and properly be included within the scope of this contribution to the art.

1. A computer-“reflected” mirror system comprising, at a minimum:
a flat-panel display subsystem having a computer interface and suitable for displaying a computer-generated image;
at least one of a set of subject sensors capable of detecting the presence and orientation of human body parts by optical (visible and/or infrared), ultra-sonic and/or electromagnetic means, such sensors located within and/or around the plane of said display subsystem;
a data storage system capable of storing one or more models of the body parts expected to comprise a human being and a multitude of digital images of “avatar” body parts comprising one or more different visual representations for each of the body parts in said models;
a computer-based image processing subsystem capable of integrating information from the sensors, selecting a model from storage at random, assembling a set of “avatar” body part images from storage to fit this model, generating a complete body image with each part “posed” or oriented to mimic the actual orientation of the subject body parts as determined from the sensor information and producing this complete image in a manner suitable to the flat-panel display subsystem.

2. The computer-“reflected” mirror system recited in claim 1, wherein one or more of the multitude of subject sensors may be mounted orthogonal to the plane of the display subsystem.

3. The computer-“reflected” mirror system recited in claim 2, wherein the multitude of subject sensors may include an optional pressure-sensitive surface located below the subject and orthogonal to the plane of the display subsystem, for the purpose of detecting the presence and position of the subject(s).

4. The computer-“reflected” mirror system recited in claim 3, wherein the image processing subsystem may utilize optional background sensors positioned above, below and/or beside the area behind the subject to detect background information for the purpose of “masking” out unwanted information collected by the set of subject sensors.

5. The computer-“reflected” mirror system recited in claim 4, wherein the image processing subsystem may utilize an optional background surface positioned behind the subject such that the subject is between said surface and the display subsystem, and which surface contains a pattern or color scheme designed to aid the subject sensors in the recognition of the boundaries of the subject body.

6. The computer-“reflected” mirror system recited in claim 5, wherein the image processing subsystem may utilize an optional array of one or more ultrasonic sensors and/or stereoscopic video cameras capable of measuring the range to objects in front of the display subsystem to aid in the discrimination of multiple subject bodies.

7. The computer-“reflected” mirror system recited in claim 6, wherein the image processing subsystem may utilize an optional keypad input subsystem for the manual selection of a desired avatar for a subject, such selection accomplished either by the subject themselves or by an operator, to over-ride the random selection by the image processing subsystem.

8. The computer-“reflected” mirror system recited in claim 7, wherein the image processing subsystem may utilize one of a set of “tags” attached to or carried by a subject, each of the set of said tags causing the selection of a different avatar for a subject, either in addition to or in place of other avatar selection methods, said “tags” being capable of actively transmitting an encoded signal to, or of passively being detected by, an optional “tag” reader attached to the image processing subsystem.

9. The computer-“reflected” mirror system recited in claim 8, wherein the image processing subsystem may utilize an optional algorithm by which specific parameters of a subject, including but not limited to height, width and general body shape, which are detectable by the subject sensors, are used to select an avatar of similar physical type for that subject, either in addition to or in place of other avatar selection methods.

10. The computer-“reflected” mirror system recited in claim 9, wherein the image processing subsystem may store and retrieve optional background images for inclusion as background for the complete image provided to the display subsystem.
